(19) United States
(12) Patent Application Publication
(10) Pub. No.: US 2005/0227547 A1
(43) Pub. Date: Oct. 13, 2005

(54) Connector for cable eyes

(76) Inventor: Hansjurg Hunziker, Zurich (CH)

Correspondence Address: QUARLES & BRADY LLP, RENAISSANCE ONE, TWO NORTH CENTRAL AVENUE, PHOENIX, AZ, 85004-2391, US

(21) Appl. No.: 10/822,247

(22) Filed: Apr. 8, 2004

(51) Int. Cl. H01R 9/22

(52) U.S. Cl. 439/709

(57) ABSTRACT

An electrical connector has a non-conductive main body (40) having raised terminal mounting portion (82) disposed on an upper surface of the main body. The electrical connector is inserted into a mounting surface (68). Barrier walls (56) electrically separate and isolate the terminal mounting portion. The terminal mounting portion have an opening for receiving a wire connection. Conductive terminals (90) are coupled to the terminal mounting portion and have shafts (94) extending through slots (80) in the main body to a bottom surface of the main body. A first and second flexible side flanges (50,52) have barbed-edges and are coupled to first and second side surfaces of the main body, respectively. The first and second side flanges are compressed during insertion into an opening of the mounting surface and snap back when the barbed-edge of the first and second side flanges clear the mounting surface. A cover assembly (110) is disposed over the main body.

### FIELD OF THE INVENTION

The present invention relates in general to electronic cable connectors and, more particularly, to an electrical connector having a flexible side flange for easy insertion into a mounting surface while providing a small footprint.

### BACKGROUND OF THE INVENTION

Most modern electronic equipment require a power supply for providing an operating potential to the electronic components contained therein. Common types of electronic equipment include computers, audio-video equipment, consumer electronics, automotive components, and other devices which utilize integrated circuits, semiconductor chips, or otherwise require DC operating potential. Most if not all semiconductor components require a low-voltage direct current (DC) operating potential. However, many sources of electric power are alternating current (AC), or high-voltage DC, which must be converted to low-voltage DC for the electronic equipment.

In one common arrangement, an AC/DC power supply receives an AC input voltage, e.g., between 110 and 240 VAC, and converts the input voltage to the DC operating voltage. The AC voltage is routed through a full-wave rectifier bridge and filtered to produce a high-voltage DC signal. The high-voltage DC signal is processed through a pulse width modulated (PWM) controller and transformer assembly to generate the low-voltage, regulated DC output voltage, which is used as the operating potential for the semiconductor components and other devices requiring low-voltage DC supply in the electronic equipment. The low-voltage DC signal is typically in the range of 5 to 12 VDC. In other cases, a DC/DC power supply receives a high-voltage DC signal and provides the low-voltage DC signal necessary for the electronic equipment.

The power supply itself is generally an electrical component or assembly of the overall system. The power supply must be installed during original manufacture, and replaced if it fails. Accordingly, the power supply is made detachable and serviceable with physical electrical connectors on the input and output. The input of power supply must be physically connected to the AC power source or the high-voltage DC power source, and the output of the power supply must be physically connected to the electronic circuits requiring the low-voltage DC operating potential.

In the prior art, the electrical connectors are typically mounted to a chassis or printed circuit board (PCB) of the power supply. On the input side, the wires from the AC or DC power source are attached to a first connector on the power supply. On the output side, the wires for the low-voltage DC signal are connected to a second connector on the power supply. The wires on the output side route the low-voltage DC signal to the electronic equipment. The connectors may be soldered in place or attached with screws or nuts and bolts. If the connector is soldered in place, it may be difficult to remove should the connector fail. Moreover, there is extra manufacturing time and cost involved with soldering and de-soldering the connector from the PCB.

If the connector is attached to the chassis or PCB with screws or nuts and bolts, then the connector is generally configured with side wings or anchors to provide a surface to secure the connector. The anchors are typically located on either side of the main body of the connector. The screw is run through an opening in the anchor to hold the connector in place on the chassis or PCB. The anchors of the connector take up additional space, in excess of the footprint of the main body of the connector, on the chassis or PCB mounting surface. The additional space needed for an anchor-configured connector reduces space available on the chassis or PCB for other components. Moreover, the anchors of the connector are a weaker portion of the assembly and may break under stress. There is manufacturing time required to screw the connector in place, and the connector may loosen over time in high vibration environments, or if not properly tightened during installation. The screw-mounted connector also imposes maintenance issues when it needs to be replaced.

A need exists to mount an electrical connector without soldering or securing with screws or nuts and bolts.

### SUMMARY OF THE INVENTION

In one embodiment, the present invention is an electrical connector comprising a main body having a plurality of terminal mounting portions disposed on an upper surface of the main body. A plurality of terminals are coupled to the plurality of terminal mounting portions and have shafts extend through slots in the main body to a bottom surface of the main body. A first side flange has a barbed-edge and is coupled to a first side surface of the main body. A second side flange has a barbed-edge and is coupled to a second side surface of the main body.

In another embodiment, the present invention is an electrical connector comprising a main body having a terminal mounting portion disposed on a first surface of the main body. A first flange has a ridge portion and is coupled to a second surface of the main body.

In another embodiment, the present invention is an assembly for connecting to an electrical conductor comprising a non-conductive body having a terminal mounting portion disposed on a first surface of the body. A first clip is coupled to a second surface of the body. The first clip is compressible for mounting.

In yet another embodiment, the present invention is a method of forming a non-conductive body having a terminal mounting portion disposed on a first surface of the body, and forming a first flange having a ridge portion which is coupled to a second surface of the body, wherein the first flange is compressible for mounting.

In still another embodiment, the present invention is a power supply comprising a power converter circuit and an electrical connector coupled to the power converter circuit. The electrical connector includes a main body having a terminal mounting portion disposed on a first surface of the main body. A first flange has a ridge portion and is coupled to a second surface of the main body.

### BRIEF DESCRIPTION OF THE DRAWINGS

FIG. 1 is a block diagram of a power supply with electrical connectors between power source and electronic equipment;

FIG. 2 illustrates a perspective view of the electrical connector of FIG. 1;

FIG. 3 illustrates a side view of the electrical connector;

FIG. 4 illustrates a side view of the electrical connector installed in a mounting surface;

FIG. 5 illustrates a top view of the electrical connector;

FIG. 6 illustrates a side view of the electrical connector;

FIG. 7 illustrates a bottom view of the electrical connector;

FIG. 8 illustrates a perspective view of the electrical connector from an upper orientation;

FIG. 9 illustrates a perspective view of the electrical connector from a lower orientation;

FIG. 10 illustrates a perspective view of the electric terminal and shaft;

FIG. 11 illustrates a side view of the electrical terminal and shaft;

FIG. 12 illustrates a perspective view of a cover for the electrical connector; and

FIG. 13 illustrates a perspective view of the cover attached to the electrical connector.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

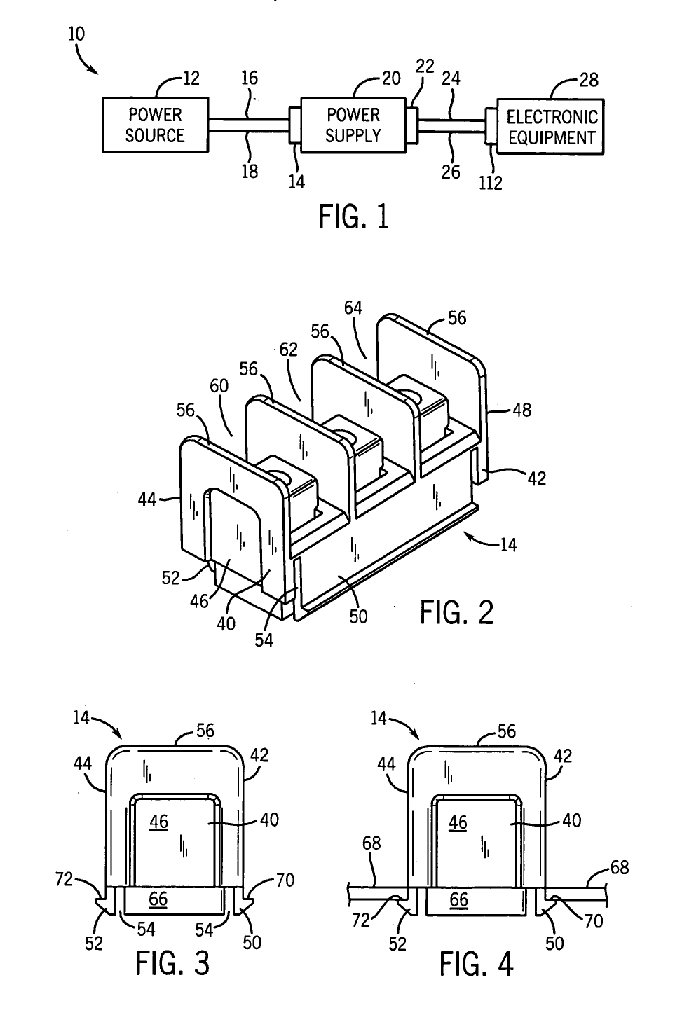

Referring to FIG. 1, an electrical system 10 is shown including power source 12. Power source 12 provides AC voltage in the range of 110-240 VAC. Alternatively, power source 12 may be a power supply bus which provides a DC voltage, e.g., 48 VDC. Power source 12 is connected to electrical connector 14 by way of wires or conductors 16 and 18. Connector 14 is the physical electrical input of power supply 20. Power supply 20 is an electronic assembly, which converts the input voltage to a low-voltage DC output signal.

Briefly, power supply 20 receives the AC power supply voltage or DC power supply voltage. In the case of receiving AC power supply voltage, a full-wave rectifier bridge converts the AC signal to a high-voltage DC signal. Power supply 20 uses a PWM controller and transformer assembly to convert the high-voltage DC signal to a regulated, low-voltage DC signal.

Power supply 20 is implemented on a PCB, and may be enclosed within a housing or chassis. Connector 14 is mounted or attached to the housing, chassis, PCB of power supply 20, or other solid plate or surface. Power supply 20 further includes electrical connector 22 for providing the low-voltage DC output signal. Connector 22 is also mounted or attached to the housing, chassis, PCB of power supply 20, or other solid plate or surface. The low-voltage DC output signal is routed along wires or conductors 24 and 26 to electronic equipment 28. Electronic equipment 28 may be a computer, communication network, audio-video equipment, consumer electronics, automotive component, energy system, telecommunication equipment, motor control, or other device containing integrated circuits, semiconductor chips, or otherwise requiring DC operating voltage.

A perspective view of electrical connector 14 is shown in FIG. 2. Electrical connector 22 has a similar configuration or implementation as described for connector 14. Connector 14 has a main body 40, which is generally rectangular in shape. In one embodiment, connector 14 is 30 millimeters (mm) long, 15 mm wide, and 20 mm high. Main body 40 is made with plastic, polymer (PBT GF 30 UL 94 V0 black), or other electrically non-conductive material. Main body 40 has a first long side 42 and a second long side 44 opposite the first long side 42. Main body 40 further has short sides 46 and 48. Main body 40 may have other shapes such as square, curved, L-shaped, T-shaped, or other irregular-shape.

A flexible flange or clip 50 with barbed-edge runs substantially the length of long side 42. The barbed-edge has a beveled portion and a ridge portion as shown in FIG. 2. The flexible flange 50 may be provided along only a portion of long side 42. Another flexible flange or clip 52 with barbed-edge runs substantially the length of long side 44. In another embodiment, flanges 50 and 52 may be run along short sides 46 and 48. Flanges 50 and 52 each have a gap 54 between main body 40 and their inner side surface.

A top portion of main body 40 has separators or barrier walls 56, extending upward from main body 40, which serve to physically and electrically isolate compartments or open areas 60, 62, and 64 of connector 14. Barrier walls 56 may enclose two sides of compartments 60-64, or three sides of compartments 60-64, or four sides of compartments 60-64. In the embodiment shown in FIG. 2, barrier walls 56 are formed on two sides compartments 60-64, leaving two sides open for the connection of a wire within each of the compartments. Barrier walls 56 prevent electrical conduction between the wires or electrically-exposed surfaces in adjacent compartments. The electrical terminal in compartment 60 must not come in contact with the electrical terminal in compartment 62, and the electrical terminal in compartment 62 must not come in contact with the electrical terminal in compartment 64.

A side view of the short side 46 of electrical connector 14 is shown in FIG. 3. Components having a similar function are assigned the same reference number throughout the figures. Further detail of flanges 50 and 52 is shown with gap 54 between flange 50 and main body 40, and between flange 52 and main body 40. Notice that, in its relaxed state, flanges 50 and 52 align with long sides 42 and 44 of main body 40. When connector 14 is installed in the chassis or PCB or mounting surface 68 of power supply 20, a lower portion 66 of main body 40 slides into an opening in mounting surface 68, see FIG. 4. The opening in mounting surface 68 is sufficiently wide that flanges 50 and 52 and lower portion 66 fit into the opening. As connector 14 is inserted into the opening of mounting surface 68, the beveled portions or edges of flanges 50 and 52 cause the flanges to compress or flex inward toward main body 40 as it passes through the opening in mounting surface 68. The gaps 54 decrease as the barbed-edges of flanges 50 and 52 pass through the opening in mounting surface 68. Flanges 50 and 52 are made with elastic or flexible material such that when connector 14 is fully inserted into the opening in mounting surface 68, the flanges snap back under the surface of mounting surface 68. Ridges 70 and 72 lock under the surface of mounting surface 68 to securely hold connector 14 in place. FIG. 4 shows electrical connector 14 locked into place in mounting surface 68.

When electrical connector 14 is fully installed in mounting surface of power supply 20, connector 14 as a whole has substantially the same footprint as main body 40. Electrical connector 14 does not require additional space for any wing or anchor to screw or bolt the connector in place, as found in the prior art. Instead, flanges 50 and 52 securely hold connector 14 to mounting surface 68, with a footprint substantially the size of main body 40. Moreover, connector 14 does not require manufacturing steps of screwing the connector to the power supply, and unscrewing the connector for maintenance or servicing. Connector 14 simply snaps into place by hand or machine insertion with minimal effort. No special tools are needed. Flanges 50 and 52 hold connector 14 securely to mounting surface 68 over time and in high vibration environments, thereby reducing failures and maintenance. Connector 14 is removed by compressing the sides of flanges 50 and 52 to retract ridges 70 and 72 from under mounting surface 68. The snap-in-place feature may reduce manufacturing defects and operator error as compared to screw-in-place type connectors.

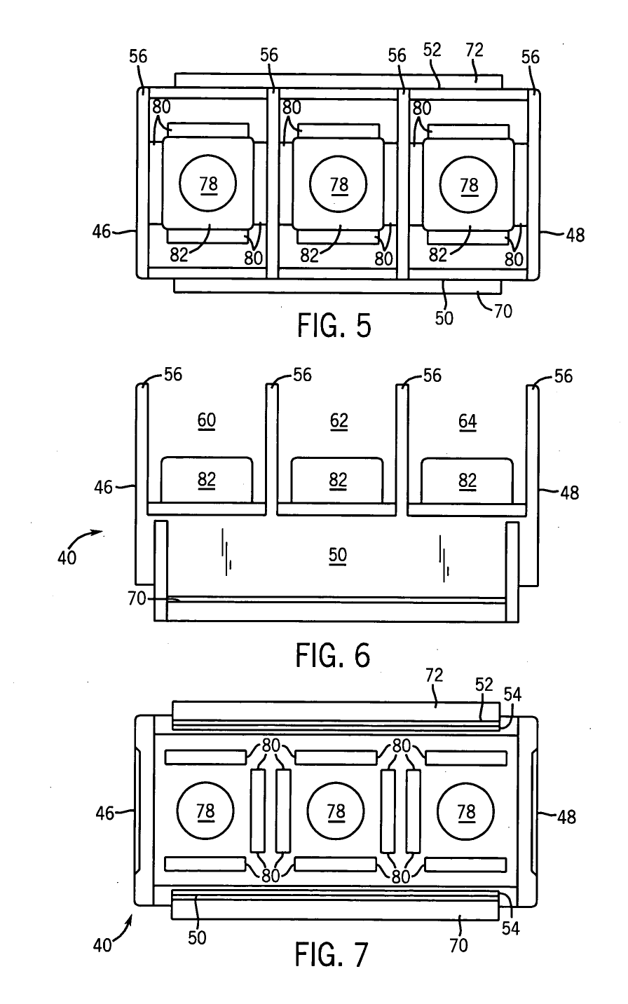

A top view of electrical connector 14 is shown in FIG. 5. A hole or opening 78 is formed in main body 40, within each compartment 60-64. Hole 78 is positioned substantially in the center of a raised terminal mounting portion 82 of main body 40. Slots 80 are formed around raised terminal mounting portion 82. There are 3-4 slots 80 surrounding each raised terminal mounting portion 82 of main body 40.

A side view of electrical connector 14 is shown in FIG. 6. A bottom view of electrical connector 14 is shown in FIG. 7. Slots 80 extend through main body 40. Holes 78 may or may not extend through main body 40.

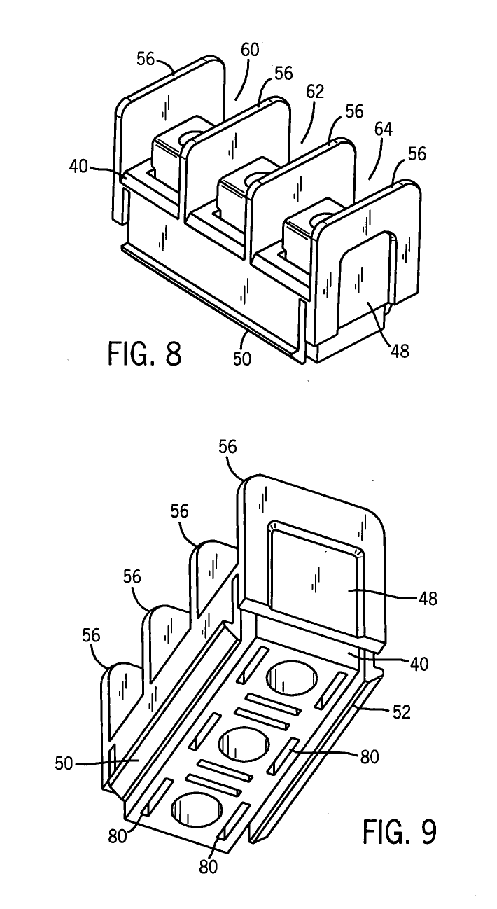

FIG. 8 shows a perspective view of electrical connector 14 from an upper orientation. FIG. 9 illustrates a perspective view of electrical connector 14 from a lower orientation.

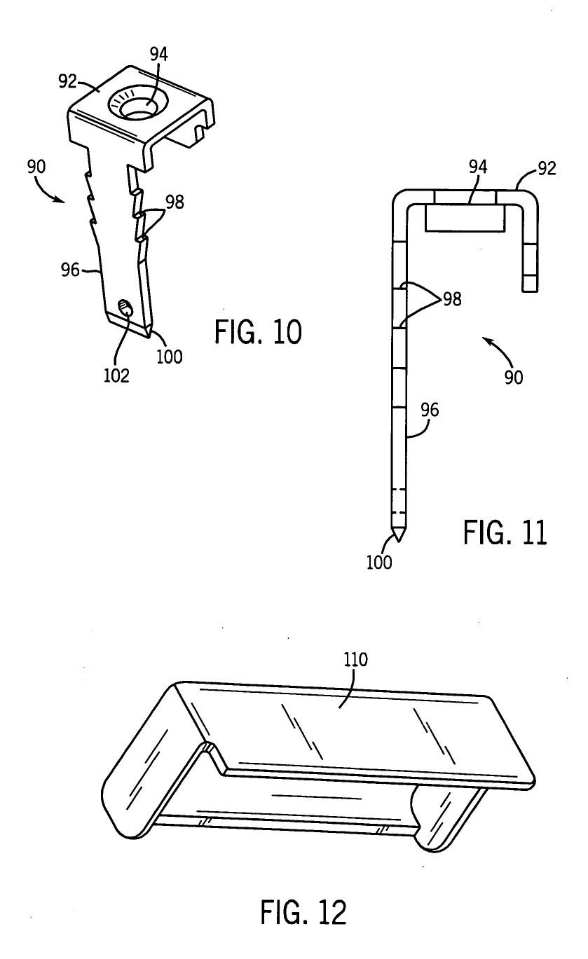

Turning to FIG. 10, electrical contact or wiring terminal 90 is shown. Terminal 90 is metallic, typically made with nickel-plated brass, which is electrically conductive. Terminal 90 has a flat portion 92 which fits over raised terminal mounting portion 82 of main body 40. The raised terminal mounting portion 82 provides a flat surface protruding up from main body 40 to secure flat portion 92 of terminal 90. Flat portion 92 is about 9 mm square. Flat portion 92 has opening 94 which aligns with hole 78 in terminal mounting portion 82. Shaft 96 of terminal 90 is about 22 mm in length and designed to slide into one of the slots 80. Terminal 90 locks into place with teeth or jagged-edge 98 catching on ridges internal to slot 80. Terminal tail or end 100 extends, say about 5 mm, out the bottom of slot 80 from main body 40. Terminal 90 can be placed in any one of the slots 80 within a respective compartment, depending on the PCB configuration.

Wire 16, with an eyelet crimped onto the end of the wire, is connected to flat portion 92 of terminal 90 with a screw or other connection hardware that is tightened into hole 78 of terminal mounting portion 82. The screw extends through the eyelet of wire 16, opening 94 in flat portion 92 of terminal 90, and into hole 78 of terminal mounting portion 82. Hole 78 need be only as deep as necessary to accommodate the screw, or hole 78 may extend completely through main body 40. Opening 94 is beveled downward around its circumference to securely hold wire 16. The PCB of power supply 20 makes electrical connection with terminal 90 by soldering terminal end 100 to an electrical connection on the PCB. Alternatively, the electrical connection can be made by screwing an eyelet or clip into hole 102, which in turn is attached to a wire connecting to the PCB. In yet another embodiment, terminal end 100 is mated into a friction or pressure fit electrical receptacle on the PCB of power supply 20. The pressure fit receptacle, in combination with flanges 50 and 52, makes for easy removal of connector 14. Wire 16 may be soldered to flat portion 92 of terminal 90, or terminal 90 may be directly soldered to the PCB.

A side view of terminal 90 is shown in FIG. 11. Terminal 90 may have multiple shafts like 96 for additional current carrying capacity or for making connections to multiple nodes on the PCB of power supply 20. Each of the multiple shafts 96 would be placed into one of slots 80 within compartments 60-64.

A terminal 90 is placed into one or more slots 80 of compartments 60-64. Wires 16 and 18 are attached to the terminals 90 in compartments 60 and 62, respectively. A third wire may be attached to terminal 90 in compartment 64 for earth ground, or other option for power supply 20. The wires may be attached to terminals 90 with a screw, as discussed above, or by nut and bolt arrangement, or with friction or pressure fit receptacle, or other connection hardware, which securely holds the wires to connector 14.

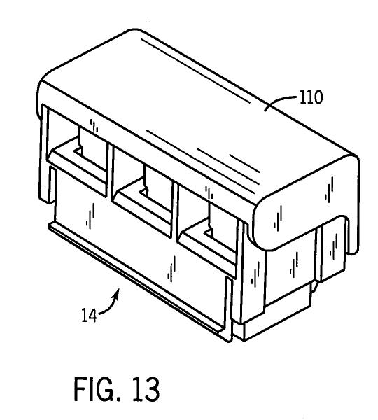

A cover assembly 110 is shown in FIG. 12. Cover assembly 110 is clipped, hinged, or screwed onto the top of connector 14 as shown in FIG. 13. Cover assembly provides further electrical and physical isolation in the final assembly after wires 16 and 18 are attached.

In another embodiment, connector 14 has a flexible flange like 50 on one side surface and one or more fixed flanges on the opposite side surface. The fixed flanges are inserted into the opening of the mounting surface, with connector 14 tilted at an angle. Once the fixed flanges are hooked under the mounting surface, the flexible flange is pressed down and snapped into place.

The electrical connector design as described above may be used in many other electrical connection applications. For example, wires 24 and 26 may connect to electrical equipment 28 using connector 112, which is implemented in a similar manner as connectors 14 and 22. The electrical connectors 14, 22, and 112 have uses anywhere it is necessary to attach one or more wires to a fixed or solid surface.

1. An assembly for supplying electric power to a printed circuit board, comprising:
a main body having a plurality of terminal mounting portions disposed on an upper surface of the main body;
a plurality of terminals coupled to the plurality of terminal mounting portions, wherein each of the plurality of terminals includes a substantially flat surface for securing wire hardware and a shaft extending through a slot in the main body to a bottom surface of the main body;
a first side flange having a barbed-edge and coupled to a first side surface of the main body; and
a second side flange having a barbed-edge and coupled to a second side surface of the main body, wherein the first and second side flanges are operable to allow the main body to readily disengage from the printed circuit board while giving the assembly a footprint on the printed circuit board of substantially the size of the main body.

2. The assembly of claim 1, wherein a portion of the first and second side flanges are disposed apart from the main body to form a gap between the portion of the first and second side flanges and the main body.

3. The assembly of claim 2, wherein the first and second side flanges are made with a flexible material.

4. The assembly of claim 3, wherein the electrical connector is adapted for insertion into a mounting surface.

5. The assembly of claim 4, wherein the first and second side flanges are adapted for compressing during insertion into an opening of the mounting surface and to snap back when the barbed-edges of the first and second side flanges clear the mounting surface.

6. The assembly of claim 1, further including a plurality of barrier walls separating the plurality of terminal mounting portions.

7. The assembly of claim 1, wherein the main body is made of non-conductive material.

8. The assembly of claim 1, wherein the plurality of terminals are made with a conductive material.

9. The assembly of claim 1, wherein each of the plurality of terminals includes an opening for receiving a wire connection.

10. The assembly of claim 1, wherein the shafts of the plurality of terminals each include teeth to lock into the slots in the main body.

11. The assembly of claim 1, further including a cover assembly disposed over a portion of the main body.

12. The assembly of claim 1, wherein each of the plurality of terminal mounting portions includes an opening adapted for receiving securing hardware.

13. The assembly of claim 1, wherein the electrical connector is mounted to a power supply.

14. An assembly for supplying electric power to a printed circuit board, comprising:
a main body having a terminal mounting portion disposed on a first surface of the main body;
a terminal coupled to the terminal mounting portion, wherein the terminal includes a substantially flat surface for securing wire hardware and a shaft extending through a slot in the main body to a bottom surface of the main body; and
a first flange having a ridge portion and coupled to a second surface of the main body, wherein the first flange is operable to allow the main body to readily disenage from the printed circuit board while giving the assembly a footprint on the printed circuit board of substantially the size of the main body.

15. The assembly of claim 14, further including a second flange having a ridge portion and coupled to a third surface of the main body.

16. (canceled)

17. The assembly of claim 14, wherein a portion of the first flange is disposed apart from the main body to form a gap between the portion of the first flange and the main body.

18. The assembly of claim 14, wherein the first flange is made with a flexible material.

19. The assembly of claim 14, wherein the electrical connector is adapted for insertion into a mounting surface.

20. The assembly of claim 19, wherein the first flange is adapted for compressing during insertion into an opening of the mounting surface and to snap back when the ridge portion of the first flange clears the mounting surface.

21. The assembly of claim 14, further including a barrier wall isolating the terminal mounting portion.

22. The assembly of claim 14, further including a cover assembly disposed over a portion of the main body.

23. The assembly of claim 14, wherein the electrical connector is mounted to an electronic assembly.

24. The assembly of claim 23, wherein the electronic assembly is a power supply.

25. An assembly mounted on a printed circuit board for connecting to electrical conductors, comprising:
a non-conductive body having a terminal mounting portion disposed on a first surface of the body;
a terminal coupled to the terminal mounting portion, wherein the terminal includes a substantially flat surface for securing wire hardware and a shaft extending through a slot in the body to a bottom surface of the body; and
a first clip coupled to a second surface of the body, wherein the first clip is compressible for mounting on the printed circuit board while giving the assembly a footprint on the printed circuit board of substantially the size of the body.

26. The assembly of claim 25, further including a second clip coupled to a third surface of the body, wherein the second clip is compressible for mounting.

27. The assembly of claim 25, further including a terminal coupled to the terminal mounting portion and having a shaft extending through a slot in the body to a bottom surface of the body.

28. The assembly of claim 25, wherein a portion of the first clip is disposed apart from the body to form a gap between the portion of the first clip and the body.

29. The assembly of claim 25, further including a barrier wall isolating the terminal mounting portion.

30-34. (canceled)

35. A power supply mounted on a printed circuit board, comprising;
a power converter circuit; and
an electrical connector coupled to the power converter circuit, the electrical connector including:
(a) a main body having a terminal mounting portion disposed on a first surface of the main body,
(b) a terminal coupled to the terminal mounting portion, wherein the terminal includes a substantially flat surface for securing wire hardware and a shaft extending through a slot in the main body to a bottom surface of the main body, and
(c) a first flange having a ridge portion and coupled to a second surface of the main body, wherein the first flange is operable to allow the main body to readily disengage from the printed circuit board while giving the assembly a footprint on the printed circuit board of substantially the size of the main body.

36. The power supply of claim 35, further including a second flange having a ridge portion and coupled to a third surface of the main body.
